(19) United States
(12) Patent Application Publication
(10) Pub. No.: US 2004/0009587 A1
(43) Pub. Date: Jan. 15, 2004

(54) Convertible rotating composter, for residential use

(76) Inventor: Todd A. Hoeschler, Denver, CO (US)

Correspondence Address: Todd Allen Hoeschler, 2540 S. Gilpin Street, Denver, CO, 80210, US

(21) Appl. No.: 10/191,343

(22) Filed: Jul. 9, 2002

(51) Int. Cl. C05F 9/02

(52) U.S. Cl. 435/290.3

(57) ABSTRACT

This nonprovisonal utility patent application is for a new type of backyard composter The composter is “convertible” and converts from a “closed” unit (with two black panels in place to an “open” unit (with two panels removed, and the screens revealed). The screens allow only fully decomposed matter to filter out, when the bin is rotated. The scope of protection offered by the patent should prevent the manufacture of a residential rotating composting device with removable panels with screens behind them.

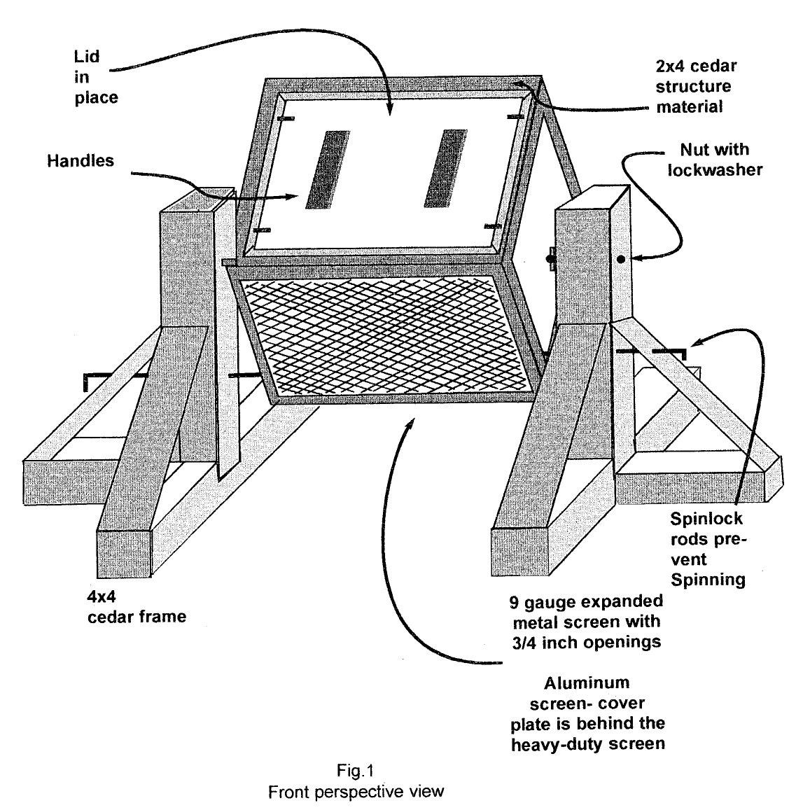

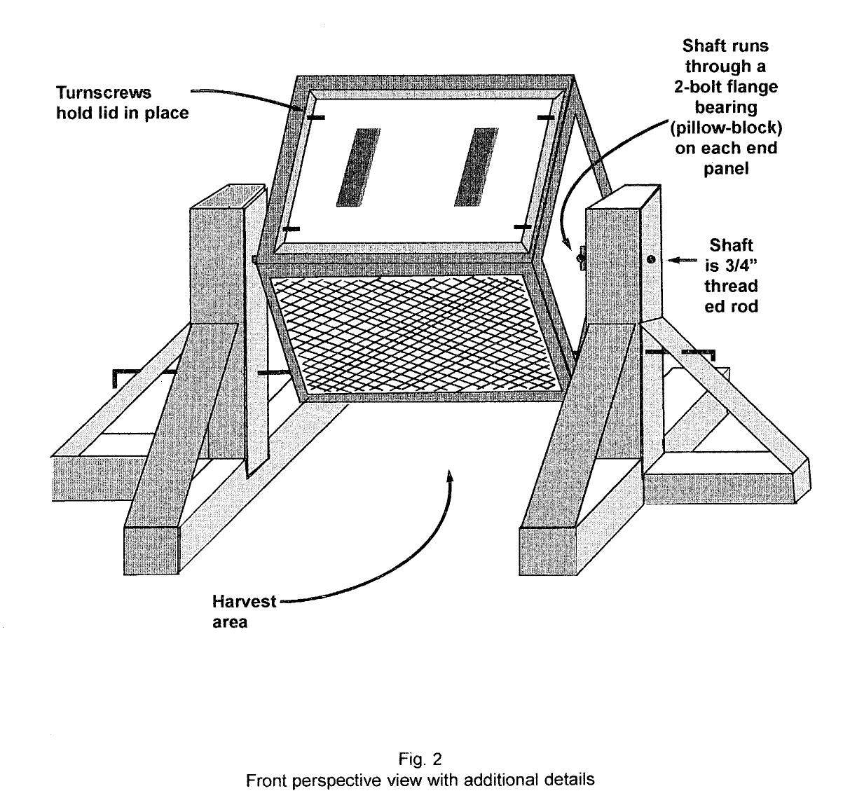

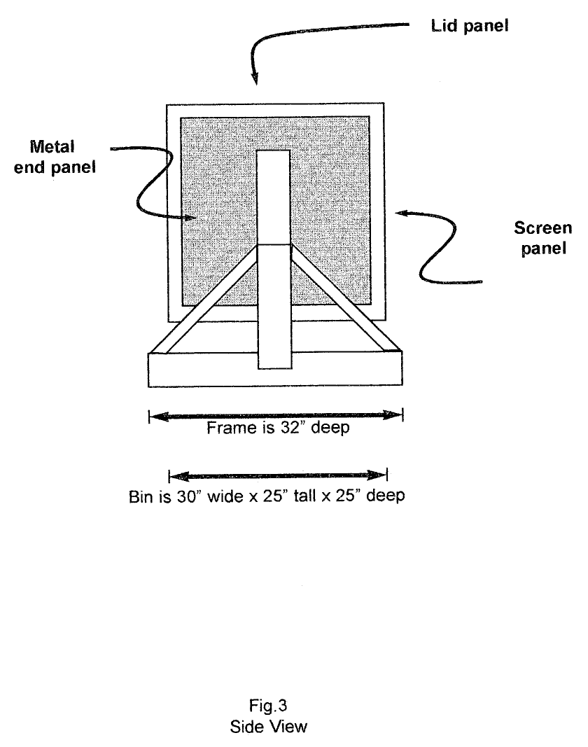

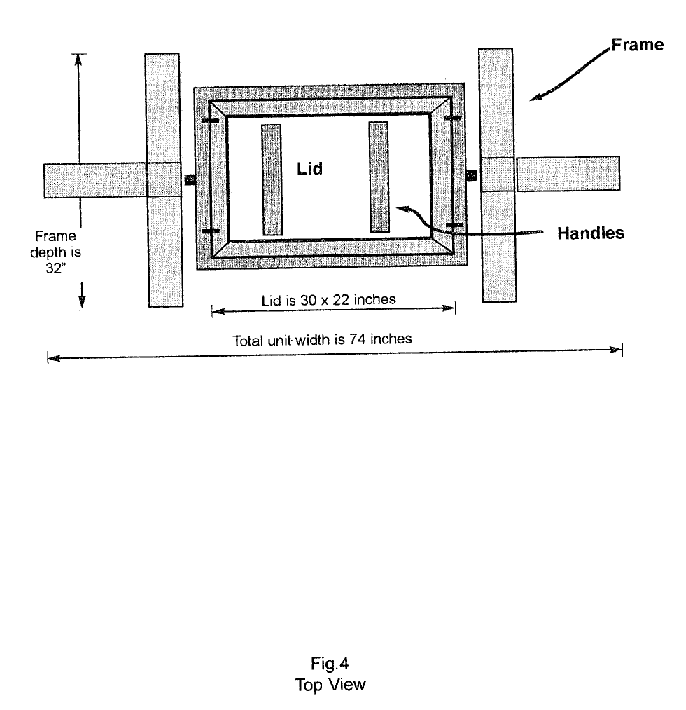

### DESCRIPTION OF THE INVENTION

The Invention is a rotating composter, which converts yard and kitchen scraps into garden fertilizer. The rotating unit has two large black panels which are removable, and therefore the bin is convertible. When the panels are in place, airflow is reduced, and the unit is able to attain warmer interior temperatures, which provides a suitable habitat for microbial activity, which begins the decomposition process. One the yard waste has fully, or even partially decomposed, the user simply removes the two large

black panels. When these two panels are removed, they reveal a mesh metal screen behind them. The gardener then rotates the bin to sift out only the finished compost. This eliminates much of the manual labor associated with traditional composting; separating roughage from finished compost.

Both the Framework and the bin of this rotating, unit are built with outdoor Cedar 4×4 posts and 2×4's. The interior capacity is approximately 12 cubic feet, which is approximately half of a cubic yard. The unit spins on a galvanized bearing, which is 36 inches long with an outside diameter of 2 inches.

The black Panels are made from 1/16 inch black neoprene rubber, and they are attached to a rectangular 2×4 frame, with 45 degree mitred corners. They cover a mesh screen that is made from one-half inch hardware cloth. The unit spins on a metal bearing which is a 36 inch galvanized conveyor roller bearing. The two ends of the bin feature reinforced vinyl window screen for ventilation. The bin is 39.5 inches wide, and 25 inches tall, and 25 inches deep. The frame is 40 inches tall. The panels and lid are attached to the bin with several 4 inch metal turnscrews made from ¾ inches angle iron, and painted black. The unit is assembled with outdoor deck screws, exterior gale and galvanized hardware.

### DRAWINGS PROVIDED

Drawing 1 Perspective Views of Composter Unit (showing panels in place, and also removed)

Drawing 2 Front Views of Composter (showing panels in place, and also removed)

Drawing 3 Top and Side View of Composter Unit

### BACKGROUND OF THE INVENTION

This invention serves the community, and allows citizens to reduce landfill waste by converting their yard and kitchen waste into useable compost. This unit has been invented and refined by the inventor; Todd Allen Hoeschler. The general field of endeavor is gardening.

### SUMMARY OF THE INVENTION

This invention reduces the labor involved in aerating and harvesting backyard compost. By incorporating a convertible rotating design, the unit provides the right environment for decomposition, and then changes to a sifting device. The rotational function of the bin provides a means of keeping the organic material turned and aerated regularly, as well as provides an efficient way to sift out the finished compost.

1. What I claim as my invention is the convertible aspect of this rotating composter. The scope of protection offered by the patent should prevent the manufacture of a rotating device with removable panels with sifting screens behind them.
